(19) United States
(12) Patent Application Publication
(10) Pub. No.: US 2011/0112226 A1
(43) Pub. Date: May 12, 2011

(54) Products with improved flame resistance

(75) Inventors: Claus Rudiger, Krefeld (DE); Berit Krauter, Krefeld (DE); Michael Wagner, Moers (DE)

(73) Assignee: Bayer MaterialScience AG, Leverkusen (DE)

(21) Appl. No.: 12/082,225

(22) Filed: Apr. 9, 2008

(30) Foreign Application Priority Data
Apr. 13, 2007 (DE) 10 2007 017 936.9

(51) Int. Cl. C08K 5/3492

(52) U.S. Cl. 524/100

(57) ABSTRACT

The present invention relates to a composition containing polycarbonate and 0.0001 wt. % to 0.5 wt. % 2-[2-hydroxy-4-(2-ethylhexyl)oxy]phenyl-4,6-di(4-phenyl)phenyl-1,3,5-triazine (CAS No. 204583-39-1) and 0.01 wt. % to 30.00 wt. % of a flameproofing additive.

### CROSS-REFERENCE TO RELATED APPLICATION

This application claims priority under 35 U.S.C. §119(a-d) to German Application Serial No. 10 2007 017936.9, filed Apr. 15, 2007.

### FIELD OF THE INVENTION

The present invention relates to a composition containing polycarbonate and 0.0001 wt. % to 0.5 wt. % 2-[2-hydroxy-4-(2-ethylhexyl)oxy]phenyl-4,6-di(4-phenyl)phenyl-1,3,5-triazine (CAS No. 204583-39-1) and 0.01 wt. % to 30.00 wt. % of a flameproofing additive.

### BACKGROUND OF THE INVENTION

Flameproofed synthetic moulding materials are employed for a large number of applications. Typical fields of application of such synthetic materials are electrical engineering and electronics, where they are employed, inter alia, for the purpose of producing carriers of voltage-carrying components or in the form of television housings and monitor housings. But flameproofed synthetic materials have also established themselves in the field of interior trims of rail vehicles and aircraft. In addition to good flameproofing properties, the synthetic materials that are used in this field must also display further positive properties at a high level. These include, inter alia, mechanical properties such as, for example, high impact strength and also sufficient long-term stability as regards thermal stress or as regards possible damage through the action of light. Such a combination of properties is not easy to attain. Although the desired flame resistance in synthetic materials can, as a rule, be adjusted easily with the aid of flameproofing agents, relatively large quantities are often required for this purpose, which rapidly results in a drastic deterioration of other properties, such as mechanical properties for example.

In this context US 2003/0069338 discloses flameproofed moulding materials that contain synergistic combinations of cyanoacrylates and flameproofing agents. The moulding materials that have been finished in this way are distinguished by an improved flame resistance and an improved weathering resistance.

EP 1 308 084 discloses polymer compositions that may additionally contain, besides a specific combination of UV absorbers, flameproofing agents which are not specified in any detail.

EP 1 762 591 describes compositions containing polycarbonate and defined UV-absorbers of the type represented by 2,4-bis-(4-phenylphenyl)-6-(2-hydroxyphenyl)-1,3,5-triazines and optionally further stabilisers. Flameproofing agents are not the subject of this application.

Light-stable structures are claimed in US 2004/0209020 that contain, inter alia, polymer films provided with triazine-containing UV-absorbers.

US 2006/0234061 describes multilayer systems comprising a UV-protecting layer, which contains polyalkylene(meth)acrylate and compounds of the type represented by 2,4-bis-(4-phenylphenyl)-6-(2-hydroxyphenyl)-1,3,5-triazines, and also a second layer containing polycarbonate.

Biphenyl-substituted triazine compounds are described in U.S. Pat. No. 6,255,483 and also in GB 2 317 174. Mixtures with further additives are mentioned in general form. However, no specific teaching relating to the preparation of compositions having improved flameproofing properties can be gathered from this document.

2-[2-hydroxy-4-(2-ethylhexyl)oxy]phenyl-4,6-di(4-phenyl)phenyl-1,3,5-triazine (CAS No. 204583-39-19) has been described as a UV-absorber, for example in EP 1 308 084.

### SUMMARY OF THE INVENTION

An object of the present invention is the provision of compositions containing polycarbonate that exhibit improved flameproofing properties.

Within the scope of the present invention it has been found that the finishing of compositions containing polycarbonate with a synergistic combination of a flameproofing agent and small quantities of 2[2-hydroxy-4-2(hydroxy-4-(2-ethylhexyl)oxy]phenyl-4,6-di(4-phenyl)phenyl-1,3,5-triazine (CAS No. 204583-39-1) improves the flameproofing properties of the composition to a surprisingly clear extent.

The present invention consequently relates to a composition containing polycarbonate and 0.0001 wt. % to 0.5 wt. % 2-[2-hydroxy-4-(2-ethylhexyl)oxy]phenyl-4,6-di(4-phenyl)phenyl-1,3,5-triazine (CAS No. 204583-39-19) and 0.005 wt. % to 30.00 wt. % of a flameproofing additive.

The expression “0.005 wt. % to 30.00 wt. % of a flameproofing additive” here is not restricted to a single flameproofing additive but also encompasses mixtures of flameproofing additives.

Such compositions can be employed advantageously in diverse applications. These include, for example, applications in the electrical/electronics field, such as, for example, lamp housings, electrical circuit-breakers, multipoint connectors or television and monitor housings. The compositions according to the invention may furthermore be employed in the form of sheets for architectural or industrial glazings, as trims of rail-vehicle and aircraft interiors, which in each instance are subject to stringent requirements in terms of flame resistance.

The present invention also relates to processes for producing a composition according to the invention, characterised in that polycarbonate and 0.0001 wt. % to 0.5 wt. % 2-[2-hydroxy-4-(2-ethylhexyl)oxy]phenyl-4,6-di(4-phenyl)phenyl-1,3,5-triazine (CAS No. 204583-39-1) and 0.01 wt. % to 30.00 wt. % of a flameproofing additive are brought together and mixed, optionally in solvent, whereby homogenisation is optionally effected and the solvent is removed.

### DETAILED DESCRIPTION OF THE INVENTION

Polycarbonates for the compositions according to the invention are homopolycarbonates, copolycarbonates and thermoplastic polyester carbonates.

The polycarbonates and copolycarbonates according to the invention generally have mean molecular weights (weight average) from 2000 to 200,000, preferably 3000 to 150,000, in particular 5000 to 100,000, quite particularly preferably 8000 to 80,000, in particular 12,000 to 70,000 (determined by GC with polycarbonate calibration).

Moreover, within this scope they preferably have mean molecular weights M̅_{w} from 16,000 to 40,000 g/mol.

With respect to the production of polycarbonates for the compositions according to the invention, reference may be made, for example, to Schnell, “Chemistry and Physics of Polycarbonates”, Polymer Reviews, Vol. 9, Interscience Publishers, New York, London, Sydney 1964, to D.C. PREVORSEK, B. T. DEBONA and Y. KESTEN, Corporate Research Center, Allied Chemical Corporation, Morristown, N.J., 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, Bayer A G, “Polycarbonates” in Encyclopedia of Polymer Science and Engineering, Vol. 11, Second Edition, 1988, pages 648-718, and finally to Drs. U. Grigo, K. Kircher and P. R. Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, pages 117-299. Production is preferentially effected by the interphase process or the melt-transesterification process, and will firstly be described in exemplary manner on the basis of the interphase process.

Compounds to be preferably employed by way of starting compounds are bisphenols of the general formula HO—Z—OH, in which Z is a divalent organic residue with 6 to 30 carbon atoms that contains one or more aromatic groups. Examples of such compounds are bisphenols that pertain to the group comprising the dihydroxydiphenyls, bis(hydroxyphenyl)alkanes, indane bisphenols, bis(hydroxyphenyl)ethers, bis(hydroxyphenyl)sulfones, bis(hydroxyphenyl)ketones and α,α′-bis(hydroxyphenyl)diisopropylbenzenes.

Particularly preferred bisphenols that pertain to the aforementioned groups of compounds are bisphenol A, tetraalkyl bisphenol A, 4,4-(meta-phenyldiisopropyl)diphenol(bisphenol M), 4,4-(para-phenylenediisopropyl)diphenol, N-phenylisatine bisphenol, 1,1-bis-(4-hydroxyphenyl)-3,3,5-trimethylcyclohexane (BP-TMC), bisphenols of the type represented by 2-hydroxycarbyl-3,3-bis(4-hydroxyaryl)phthalimidines, in particular 2-phenyl-3,3-bis(4-hydroxyphenyl)phthalimidine, and also, optionally, mixtures thereof. Particularly preferred are homopolycarbonates based on bisphenol A and copolycarbonates based on the monomers bisphenol A and 1,1-bis-(4-hydroxyphenyl)-3,3,5-trimethylcyclohexane. The bisphenol compounds to be employed in accordance with the invention are converted with carbonic-acid compounds, in particular phosgene or, in the case of the melt-transesterification process, diphenyl carbonate or dimethyl carbonate.

Polyester carbonates are obtained by conversion of the aforementioned bisphenols, at least one aromatic dicarboxylic acid and, optionally, carbonic-acid equivalents. Suitable aromatic dicarboxylic acids are, for example, phthalic acid, terephthalic acid, isophthalic acid, 3,3′- or 4,4′-diphenyldicarboxylic acid and benzophenonedicarboxylic acids. A portion, up to 80 mol %, preferentially from 20 mol% to 50 mol%, of the carbonate groups in the polycarbonates may be replaced by aromatic dicarboxylic-ester groups.

Inert organic solvents that are used in the case of the interphase process are, for example, dichloromethane, the various dichloroethanes and chloropropane compounds, tetrachloromethane, trichloromethane, chlorobenzene and chlorotoluene. Chlorobenzene or dichloromethane or mixtures of dichloromethane and chlorobenzene are preferentially employed.

The interphase reaction may be accelerated by catalysts such as tertiary amines, in particular N-alkylpiperidines or onium salts. Use is preferably made of tributylamine, triethylamine and N-ethylpiperidine. In the case of the melt-transesterification process, use is made of the catalysts named in DE-A 42 38 123.

The polycarbonates may be branched in deliberate and controlled manner through the use of small quantities of branching agents. Some suitable branching agents are: isatine biscresol, phloroglucinol, 4,6-dimethyl-2,4,6-tri(4-hydroxyphenyl)heptene-2; 4,6-dimethyl-2,4,6-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane; 2,2-bis[4,4-bis(4-hydroxyphenyl)cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenylisopropyl)phenyl)-orthoterephthalic ester, tetra(4-hydroxyphenyl)methane; tetra(4-(4-hydroxy-phenylisopropyl)phenoxy)methane; α,α′,α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole; 1,4-bis(4′,4″-dihydroxytriphenyl)methylbenzene and, in particular, 1,1,1-tri(4-hydroxy-phenyl)ethane and bis(3-methyl-4-hydroxyphenyl)-2-oxo-2,3-dihydroindole.

The 0.05 to 2 mol %, relative to diphenols employed, of branching agents or mixtures of the branching agents to be optionally used concomitantly may be employed together with the diphenols, but may also be added at a later stage of the synthesis.

Chain terminators may be employed. By way of chain terminators, use is preferably made of phenols such as phenol, alkylphenols such as cresol and 4-tert.-butylphenol, chlorophenol, bromophenol, cumylphenol or mixtures thereof in quantities of 1-20 mol %, preferably 2-10 mol %, per mole of bisphenol. Preferred are phenol, 4-tert.-butylphenol or cumylphenol.

Chain terminators and branching agents may be added to the syntheses separately, or alternatively together with the bisphenol.

The polycarbonate that is preferred in accordance with the invention is bisphenol A homopolycarbonate.

Alternatively, the polycarbonates according to the invention may also be produced by the melt-transesterification process. The melt-transesterification process is described, for example, in the Encyclopedia of Polymer Science, Vol. 10 (1969), Chemistry and Physics of Polycarbonates, Polymer Reviews, H. Schnell, Vol. 9, John Wiley and Sons, Inc. (1964) and also in DE-C 1 031 512.

In the case of the melt-transesterification process, the aromatic dihydroxy compounds already described in connection with the interphase process are transesterified in the melt with carbonic diesters with the aid of suitable catalysts and, optionally, further added substances.

Carbonic diesters in the sense of the invention are those of the formulae (1) and (2)

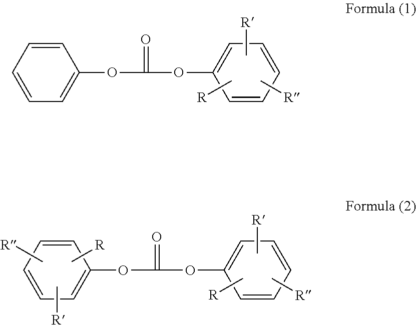

where
R, R′ and R″ may, independently of one another, represent H, optionally branched C₁-C₃₄ alkyl/cycloalkyl, C₇-C₃₄ alkaryl or C₆-C₃₄ aryl,

for example

diphenyl carbonate, butylphenyl phenyl carbonate, dibutyl phenyl carbonate, isobutylphenyl phenyl carbonate, diisobutyl phenyl carbonate, tert-butylphenyl phenyl carbonate, di-tert-butyl phenyl carbonate, n-pentylphenyl phenyl carbonate, di-(n-pentylphenyl)carbonate, n-hexylphenyl phenyl carbonate, di-(n-hexylphenyl)carbonate, cyclohexylphenyl phenyl carbonate, dicyclohexyl phenyl carbonate, phenylphenol phenyl carbonate, diphenyl phenol carbonate, isooctylphenyl phenyl carbonate, diisooctyl phenyl carbonate, n-nonylphenyl phenyl carbonate, di-(n-nonylphenyl)carbonate, cumylphenyl phenyl carbonate, dicumyl phenyl carbonate,

naphthylphenyl phenyl carbonate, dinaphthyl phenyl carbonate, di-tert-butylphenyl phenyl carbonate, di-(di-tert-butylphenyl)carbonate, dicumylphenyl phenyl carbonate, di-(dicumylphenyl)carbonate, 4-phenoxyphenyl phenyl carbonate, di-(4-phenoxyphenyl)carbonate, 3-pentadecylphenyl phenyl carbonate, di-(3-pentadecylphenyl)carbonate, tritylphenyl phenyl carbonate, ditrityl phenyl carbonate,

preferably

diphenyl carbonate, tert-butylphenyl phenyl carbonate, di-tert-butyl phenyl carbonate, phenylphenol phenyl carbonate, diphenyl phenol carbonate, cumylphenyl phenyl carbonate, dicumyl phenyl carbonate,

particularly preferably diphenyl carbonate.

Mixtures of the named carbonic diesters may also be employed.

The proportion of carbonic ester amounts to 100 to 130 mol %, preferably 103 to 120 mol %, particularly preferably 103 to 109 mol %, relative to the dihydroxy compound.

By way of catalysts in the sense of the invention, basic catalysts as described in the stated literature are employed in the melt-transesterification process, such as alkali and alkaline-earth hydroxides and oxides, for example, but also ammonium and phosphonium salts, designated in the following as onium salts. Onium salts are preferably employed in this process, particularly preferably phosphonium salts. Phosphonium salts in the sense of the invention are those of the formula (3)

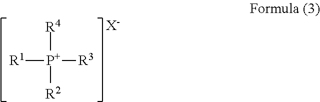

where
R¹⁻⁴ may be the same or different C₁-C₁₀ alkyls, C₆-C₁₀ aryls, C₇-C₁₀ aralkyls or C₅-C₆ cycloalkyls, preferably methyl or C₆-C₁₄ aryls, particularly preferably methyl or phenyl, and
X⁻ may be an anion such as hydroxide, sulfate, hydrogensulfate, hydrogencarbonate, carbonate, a halide, preferably chloride, or an alcoholate of the formula OR, where R may be C₆-C₁₄ aryl or C₇-C₁₂ aralkyl, preferably phenyl. Preferred catalysts are

tetraphenylphosphonium chloride,

tetraphenylphosphonium hydroxide,

tetraphenylphosphonium phenolate,

particularly preferably, tetraphenylphosphonium phenolate.

The catalysts are preferably employed in quantities from 10⁻⁸ mol to 10⁻³ mol, relative to one mol bisphenol, particularly preferably in quantities from 10⁻⁷ mol to 10⁻⁴ mol.

Further catalysts may be used on their own, or optionally in addition to the onium salt, in order to increase the speed of polymerisation. Said catalysts include salts of alkali metals and alkaline-earth metals, such as hydroxides, alkoxides and aryloxides of lithium, sodium and potassium, preferentially hydroxide salts, alkoxide salts or aryloxide salts of sodium. Most preferred are sodium hydroxide and sodium phenolate. The quantities of the co-catalyst may lie within the range from 1 to 200 ppb, preferentially 5 to 150 ppb and most preferably 10 to 125 ppb, in each instance reckoned as sodium.

The transesterification reaction of the aromatic dihydroxy compound and the carbonic diester in the melt is preferably carried out in two steps. In the first step the fusing of the aromatic dihydroxy compound and the carbonic diester takes place at temperatures from 80° C. to 250° C., preferably 100° C. to 230° C., particularly preferably 120° C. to 190° C., under normal pressure, in 0 hours to 5 hours, preferably 0.25 hours to 3 hours. After addition of the catalyst, the oligocarbonate is produced from the aromatic dihydroxy compound and the carbonic diester by distilling off the monophenol by applying vacuum (down to 2 mm Hg) and increasing the temperature (up to 260° C.). In the course of this distillation, the principal amount of vapour arising from the process accrues. The oligocarbonate produced in this way has a mean molal mass M_{w} (ascertained by measurement of the rel. solution viscosity in dichloromethane or in mixtures of the same quantities by weight of phenol/o-dichlorobenzene, calibrated by light scattering) within the range from 2000 g/mol to 18,000 g/mol, preferably from 4000 g/mol to 15,000 g/mol.

In the second step, in the course of the polycondensation the polycarbonate is produced by further increasing the temperature to 250° C. to 320° C., preferably 270° C. to 295° C., and at a pressure of <2 mm Hg. In the course of this step the residue of vapour is removed from the process.

The catalysts may also be employed in combination (two or more) with one another.

In the case of the use of alkali-metal/alkaline-earth-metal catalysts it may be advantageous to add the alkali-metal/alkaline-earth-metal catalysts at a later time (e.g. after the synthesis of oligocarbonate in the course of polycondensation in the second step).

The reaction of the aromatic dihydroxy compound and the carbonic diester to form the polycarbonate may be carried out, in the sense of the process according to the invention, discontinuously or preferably continuously, for example in stirring vessels, thin-film evaporators, falling-film evaporators, cascades of stirring vessels, extruders, kneaders, simple disc-type reactors and high-viscosity disc-type reactors.

In a manner analogous to the interphase process, branched polycarbonates or copolycarbonates may be produced through the use of polyfunctional compounds.

Other aromatic polycarbonates and/or other synthetic materials—such as aromatic polyester carbonates, aromatic polyesters such as polybutylene terephthalate or polyethylene terephthalate, polyamides, polyimides, polyester amides, polyacrylates and polymethacrylates, such as, for example, polyalkyl(meth)acrylates and here, in particular, polymethyl methacrylate, polyacetals, polyurethanes, polyolefins, halogen-containing polymers, polysulfones, polyether sulfones, polyether ketones, polysiloxanes, polybenzimidazoles, urea-formaldehyde resins, melamine-formaldehyde resins, phenol-formaldehyde resins, alkyd resins, epoxide resins, polystyrenes, copolymers of styrene or alpha-methylstyrene with dienes or acrylic derivatives, graft polymers based on acrylonitrile/butadiene/styrene or graft copolymers based on acrylate rubber (see, for example, the graft polymers described in EP-A 640 655) or silicone rubbers—may also be admixed in known manner to the polycarbonates and copolycarbonates according to the invention, for example by compounding.

The additives that are conventional for these thermoplastics—such as fillers, UV stabilisers, heat stabilisers, antistatic agents and pigments—may also be added in the conventional quantities to the polycarbonates according to the invention and also, where appropriate, to the further synthetic materials that are included; the demoulding behaviour, the flow behaviour and/or the flame resistance may optionally be improved by addition of external mould-release agents, free-flow agents and/or flameproofing agents (e.g. alkyl and aryl phosphites, phosphates, phosphanes, low-molecular carboxylic esters, halogen compounds, salts, chalk, quartz flour, glass and carbon fibres, pigments and combinations thereof). Such compounds are described, for example, in WO 99/55772, pp 15-25, EP 1 308 084 and in the corresponding chapters of the “Plastics Additives Handbook”, ed. Hans Zweifel, 5th Edition 2000, Hamer Publishers, Munich.

Suitable flameproofing agents in the sense of the present invention are, inter alia, alkali or alkaline-earth salts of aliphatic and aromatic derivatives of sulfonic acid, sulfonamide and sulfonimide, for example potassium perfluorobutane sulfonate, potassium diphenylsulfone sulfonate, N-p-(tolylsulfonyl)-p-toluenesulfimide potassium salt, N-(N′-benzylaminocarbonyl)sulfanylimide potassium salt.

Salts that may optionally be used in the moulding materials according to the invention are, for example, sodium or potassium perfluorobutane sulfonate, sodium or potassium perfluoromethane sulfonate, sodium or potassium perfluorooctane sulfate, sodium- or potassium-2,5-dichlorobenzene sulfate, sodium- or potassium-2,4,5-trichlorobenzene sulfate, sodium or potassium methyl phosphonate, sodium- or potassium-(2-phenylethylene)phosphonate, sodium or potassium pentachlorobenzoate, sodium- or potassium-2,4,6-trichlorobenzoate, sodium- or potassium-2,4-dichlorobenzoate, lithium phenylphosphonate, sodium or potassium diphenylsulfone sulfonate, sodium- or potassium-2-formylbenzene sulfonate, sodium- or potassium-(N-benzenesulfonyl)benzenesulfonamide, trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium terafluoroborate, sodium or potassium hexafluorophosphate, sodium or potassium or lithium phosphate, N-(p-tolylsulfonyl)-p-toluenesulfimide potassium salt, N-(N′-benzylamino-carbonyl)sulfanylimide potassium salt.

Preferred are sodium or potassium perfluorobutane sulfate, sodium or potassium perfluorooctane sulfate, sodium or potassium diphenylsulfone sulfonate and sodium- or potassium-2,4,6-trichlorobenzoate and N-(p-tolylsulfonyl)-p-toluenesulfimide potassium salt, N-(N′-benzylaminocarbonyl)sulfanylimide potassium salt. Quite particularly preferred are potassium nona-fluoro-1-butanesulfonate and sodium or potassium diphenylsulfonic acid sulfonate. Potassium nona-fluoro-1-butanesulfonate is, inter alia, commercially available as Bayowet®C4 (Lanxess, Leverkusen, Germany, CAS No. 29420-49-3), RM64 (Miteni, Italy) or as 3M™ Perfluorobutanesulfonyl Fluoride FC-51 (3M, USA). Mixtures of the named salts are likewise suitable.

These organic flameproofing salts are employed in the moulding materials in quantities from 0.01 wt. % to 1.0 wt. %, preferentially 0.01 wt. % to 0.8 wt. %, particularly preferably 0.01 wt. % to 0.6 wt. %, in each case relative to the total composition.

By way of further flameproofing agents, phosphorus-containing flameproofing agents, selected from the groups comprising the monomeric and oligomeric phosphoric and phosphonic esters, phosphonate amines, phosphonates, phosphinates, phosphites, hypophosphites, phosphine oxides and phosphazenes enter into consideration for example, in which connection mixtures of several components selected from one or various of these groups may find application as flameproofing agents. Other, preferably halogen-free, phosphorus compounds, not mentioned especially here, may also be employed, on their own or in arbitrary combination with other, preferably halogen-free, phosphorus compounds. These also include purely inorganic phosphorus compounds such as boron phosphate hydrate. Furthermore, phosphonate amines enter into consideration by way of phosphorus-containing flameproofing agents. The production of phosphonate amines is described in U.S. Pat. No. 5,844,028, for example. Phosphazenes and the production thereof are described, for example, in EP-A 728 811, DE-A 1 961 668 and WO 97/40092. Siloxanes, phosphorylated organosiloxanes, silicones or siloxysilanes may also find application as flameproofing agents, this being described in greater detail, for example, in EP 1 342 753, in DE 102 57 079 A and also in EP 1 188 792.

Phenyl tris-trimethylsiloxysilane (CAS No. 2116-84-9) has been employed within the scope of the present invention.

Within the scope of the present invention, phosphorus compounds of the general formula (4) are preferred

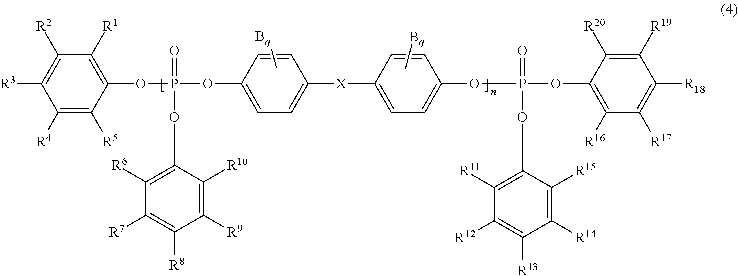

in which
R¹ to R²⁰ signify, independently of one another, hydrogen, a linear or branched alkyl group of up to 6 C atoms
n signifies an average value from 0.5 to 50 and
B signifies, in each instance, C₁-C₁₂ alkyl, preferentially methyl, or halogen, preferentially chlorine or bromine
q signifies, in each instance, independently of one another, 0, 1 or 2
X signifies a single bond, C═O, S, O, SO₂, C(CH₃)₂, C₁-C₅ alkylene, C₂-C₅ alkylidene, C₅-C₆ cycloalkylidene, C₆-C₅₂ arylene, onto which further aromatic rings, optionally containing heteroatoms, may have been condensed, or a residue of the formula (5) or (6)

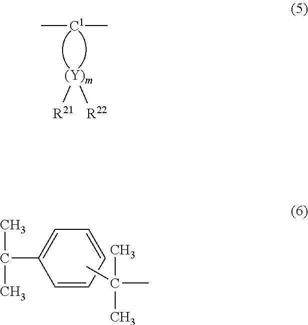

with Y carbon and
R²¹ and R²² R signify, in individually selectable manner for each Y, independently of one another, hydrogen or C₁-C₆ alkyl, preferentially hydrogen, methyl or ethyl,
m signifies an integer from 4 to 7, preferably 4 or 5, with the proviso that R²¹ and R²² are simultaneously alkyl on at least one atom Y.

Particularly preferred are those phosphorus compounds of the formula (4) in which R¹ to R²⁰ signify, independently of one another, hydrogen or a methyl residue and in which q=0. Particularly preferred are compounds in which X signifies SO₂, O, S, C═O, C₂-C₅ alkylidene, C₅-C₆ cycloalkylidene or C₆-C₁₂ arylene. Compounds with X═C(CH₃)₂ are quite particularly preferred.

The degree of oligomerisation n results as an average value from the process for producing the listed phosphorus-containing compounds. As a rule, the degree of oligomerisation in this process amounts to n<10. Preferred are compounds with n from 0.5 to 5, particularly preferably 0.7 to 2.5. Quite particularly preferred are compounds that exhibit a high proportion of molecules with n=1 between 60% and 100%, preferably between 70% and 100%, particularly preferably between 79% and 100%. By virtue of the production process, the above compounds may also contain small quantities of triphenyl phosphate. The quantities of this substance mostly amount to below 5 wt. %, with compounds that have a content of triphenyl phosphate within the range from 0% to 5%, preferably from 0% to 4%, particularly preferably from 0% to 2.5%, relative to the compound of the formula (4), being preferred in the present context.

Within the scope of the present invention the phosphorus compounds of the formula (4) are employed in quantities from 1 wt. % to 30 wt. %, preferably 2 wt. % to 20 wt. %, particularly preferably 2 wt. % to 15 wt. %, in each case relative to the total composition.

The named phosphorus compounds are known (cf. e.g. EP-A 363 608, EP-A 640 655) or can be produced in analogous manner by known methods (e.g. Ullmanns Encyclopädie der technischen Chemie, Vol. 18, p 301 ff. 1979; Houben-Weyl, Methoden der organischen Chemie, Vol. 12/1, p 43; Beilstein Vol. 6, p 177).

Particular preferred within the scope of the present invention is bisphenol A diphosphate. Bisphenol A diphosphate is commercially available, inter alia, as Reofos® BAPP (Chemtura, Ind., USA), NcendX® P-30 (Albemarle, Baton Rouge, La., USA), Fyroflex® BDP (Akzo Nobel, Arnheim, Netherlands) or CR 741® (Daihachi, Osaka, Japan).

Further phosphoric esters that can be employed within the scope of the present invention are, in addition, triphenyl phosphate, which, inter alia, is offered for sale as Reofos® TPP (Chemtura), Fyroflex® TPP (Akzo Nobel) or Disflamoll® TP (Lanxess), and resorcinol diphosphate. Resorcinol diphosphate can be purchased commercially as Reofos RDP (Chemtura) or Fyroflex® RDP (Akzo Nobel).

By way of anti-dripping agents, polytetrafluoroethylene (PTFE) may additionally be added to the moulding materials. PTFE is commercially available in diverse product grades. These include additives such as Hostaflon® TF2021 or alternatively PTFE blends such as Metablen® A-3800 (about 40% PTFE CAS 9002-84-0 and about 60% methyl methacrylate/butyl acrylate copolymer CAS 25852-37-3 from Mitsubishi-Rayon) or Blendex® B449 (about 50% PTFE and about 50% SAN [consisting of 80% styrene and 20% acrylonitrile] produced by Chemtura).

Within the scope of the present invention, PTFE is employed in quantities from 0.05 wt. % to 5 wt. %, preferably 0.1 wt. % to 1.0 wt. %, particularly preferably 0.1 wt. % to 0.5 wt. %, in each case relative to the total composition.

Further suitable flameproofing agents in the sense of the present invention are halogen-containing compounds. These include brominated compounds such as brominated oligocarbonates (e.g. tetrabromobisphenol A oligocarbonate BC-52®, BC-58®, BC-52HP® produced by Chemtura), polypentabromobenzyl acrylates (e.g. FR 1025 produced by Dead Sea Bromine (DSB)), oligomeric conversion products arising from tetrabromine bisphenol A with epoxides. (e.g. FR 2300 and 2400 produced by DSB), or brominated oligostyrenes and polystyrenes (e.g. Pyro-Chek® 68PB produced by Ferro Corporation, PDBS 80 and Firemaster® PBS-64HW produced by Chemtura).

Particularly preferred within the scope of this invention are brominated oligocarbonates based on bisphenol A, in particular tetrabromobisphenol A oligocarbonate.

Within the scope of the present invention, bromine-containing compounds are employed in quantities from 0.1 wt. % to 30 wt. %, preferably 0.1 wt. % to 20 w.%, particularly preferably 0.1 wt. % to 10 w. %, and quite particularly preferably 0.1 wt. % o 5.0 wt. %, in each case relative to the total composition.

Furthermore, chlorine-containing flameproofing agents, such as tetrachlorophthalimides for example, may be employed.

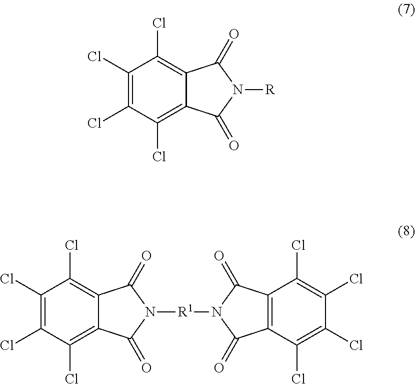

By way of suitable tetrachlorophthalimides in the sense of the invention according to formula (7), the following may be named by way of examples: N-methyl tetrachlorophthalimide, N-ethyl tetrachlorophthalimide, N-propyl tetrachlorophthalimide, N-isopropyl tetrachlorophthalimide, N-butyl tetrachlorophthalimide, N-isobutyl tetrachlorophthalimide, N-phenyl tetrachlorophthalimide, N-(4-chlorophenyl)tetrachlorophthalimide, N-(3,5-dichlorophenyl)tetrachlorophthalimide, N-(2,4,6-trichlorophenyl)tetrachlorophthalimide, N-naphthyl tetrachlorophthalimide. By way of suitable tetrachlorophthalimides in the sense of the invention according to formula (7), the following may be named by way of examples: N,N′-ethylene ditetrachlorophthalimide, N,N′-propylene ditetrachlorophthalimide, N,N′-butylene ditetrachlorophthalimide, N,N′-p-phenylene ditetrachlorophthalimide, 4,4′-ditetrachlorophthalimidodiphenyl, N-(tetrachlorophthalimido)tetrachlorophthalimide.

Particularly suitable in the sense of the invention are N-methyl and also N-phenyl tetrachlorophthalimide, N,N′-ethylene ditetrachlorophthalimide and N-(tetrachlorophthalimido)tetrachlorophthalimide.

Mixtures of various tetrachlorophthalimides of the formulae (7) or (8) may likewise be used.

Within the scope of the present invention the named chlorine-containing compounds are employed in quantities from 0.1 wt. % to 30 wt. %, preferably 0.1 wt. % to 20 wt. %, particularly preferably 0.1 wt. % to 10 wt. %, and quite particularly preferably 0.1 wt. % to 5.0 wt. %, in each case relative to the total composition.

The bromine-containing and chlorine-containing flameproofing agents may also be employed in combination with antimony trioxide.

The named flameproofing agents may be used on their own or in a mixture, but always jointly with 2-[2-hydroxy-4-(2-ethylhexyl)oxy]phenyl-4,6-d(4-phenyl)phenyl-1,3,5-triazine (CAS No. 24583-39-1). In this connection, 2-[2-hydroxy-4-(2-ethylhexyloxy]phenyl-4,6-di(4-phenyl)phenyl-1,3,5-triazine (CA No. 204583-39-1) is employed in quantities according to the invention from 0.0001 wt. % to 0.5 wt. %, preferably 0.0001 wt. % to 0.3 wt. %, particularly preferably 0.001 wt. % to 0.25 wt. %, in each case relative to the total composition.

In this connection the present invention is not restricted to the named flameproofing agents; rather, further flame-inhibiting additives—as described, for example, in J. Troitzsch “International Plastics Flammability Handbook”, Hamer Verlag, Munich 1990—may also be employed.

Production of the Compositions:

Production of a composition containing polycarbonate and 0.001 wt. % to 0.5 wt. % 2-[2-hydroxy-4-(2-ethylhexyl)oxy]phenyl-4,6-di(4-phenyl)phenyl-1,3,5-triazine (CAS No. 204583-39-1) and 0.01 wt. % to 30.00 wt. % of a flameproofing additive is effected by standard incorporation processes and may, for example, be effected by mixing of solutions of the flameproofing additive and of the 2-[2-hydroxy-4-(2-ethylhexyl)oxy]phenyl-4,6-di(4-phenyl)phenyl-1,3,5-triazine with a solution of polycarbonate in suitable solvents such as dichloromethane, haloalkanes, haloaromatics, chlorobenzene and xylolene. The substance mixtures are then preferably homogenised in known manner by extrusion. The solution mixtures are preferably reworked—compounded, for example—in known manner by evaporating the solvent and by subsequent extrusion of the mixture.

In addition, the composition may be mixed in conventional mixing appliances such as screw extruders (for example, twin-screw extruders), kneaders, Brabender or Banbury mills, and subsequently extruded. After the extrusion, the extrudate can be cooled and crushed. Individual components may also be premixed, and then the remaining initial substances may be added individually and/or likewise in the mixed state.

The compositions according to the invention may be reworked in known manner and processed into arbitrary moulded articles, for example by extrusion, injection moulding or extrusion blow moulding.

Co-extruded polycarbonate solid sheets may, for example, be produced with the aid of the following machines and appliances:
the main extruder with a screw of length 33 D and with a diameter of length 70 mm with degassing
a co-extruder for applying the top layer with a screw of length 25 D and with a diameter of 35 mm
a special co-extrusion slit die with a width of 450 mm
a smoothing calender
a roller conveyor
a take-off device
a flying knife (saw)
a stacking table.

Co-extruded polycarbonate multi-wall sheets may, for example, be produced with the aid of the following machines and appliances:
the main extruder with a screw of length 33 D and with a diameter of 70 mm with degassing
the co-ex adapter (feedblock system)
a co-extruder for applying the top layer with a screw of length 25 D and with a diameter of 30 mm
the special slit die with a width of 350 mm
the calibrator
the roller conveyor
the take-off device
the flying knife (saw)
the stacking table.

With both types of sheet the polycarbonate granulate of the base material is supplied to the feed hopper of the main extruder, the co-extrusion material to that of the co-extruder. Fusing and conveying of the respective material are effected in the respective plasticising-system cylinder/screw. The two material melts are brought together in the co-ex adapter and form a composite after leaving the nozzle and cooling. The further devices serve for the transportation, cutting to length and stacking of the extruded sheets.

Sheets without a co-extrusion layer are produced in corresponding manner, by the co-extruder either not being operated or being charged with the same polymer composition as the main extruder.

The blow moulding of polycarbonate is described in more detail, inter alia, in DE 102 29 594 and in the literature cited herein.

Flame-Resistance Tests

A large number of flame-resistance tests are known. The flame resistance of synthetic materials can, for example, be determined by the method UL94V (about this, see: a) Underwriters Laboratories Inc. Standard of Safety, “Test for Flammability of Plastic Materials for Parts in Devices and Appliances”, p 14 ff., Northbrook 1998; b) J. Troitzsch, “International Plastics Flammability Handbook”, p 346 ff., Hamer Verlag, Munich 1990). With this method, burning-times and dripping behaviour of ASTM standard test specimens are assessed.

For the classification of a flameproofed synthetic material in Flammability Class UL94V-0, in detail the following criteria have to be satisfied: in a set of 5 ASTM standard test specimens (dimensions: 127×12.7×X, with X=thickness of test specimen, e.g. 3.2, 3.0, 1.5, 1.0 or 0.75 mm) all the specimens must not burn for longer than 10 seconds after two flame treatments of 10 seconds duration with an open flame of defined height. The sum of the burning-times in the case of 10 flame treatments of 5 samples must not be greater than 50 seconds. In addition, burning dripping, complete burning-away or afterglowing of the respective test specimen must not occur for longer than 30 seconds. The classification UL94V-1 requires that the individual burning-times do not amount to longer than 30 seconds and that the sum of the burning-times of 10 flame treatments of 5 samples is not greater than 250 seconds. The total afterglow time must not amount to more than 250 seconds. The remaining criteria are identical with those mentioned above.

Classification in Flammability Class UL94V-2 obtains when burning dripping occurs in the case where the remaining criteria of classification UL94V-1 are satisfied.

The combustibility of test specimens may, furthermore, also be appraised by determination of the oxygen index (LOI according to ASTM D 2863-77).

A further test of the flame resistance consists in the glow-wire test according to DIN IEC 695-2-1. In this test, with the aid of a glowing wire at temperatures between 550° C. and 960° C. the maximum temperature is ascertained in respect of 10 test specimens (for example, in respect of sheets with geometry 60×60×2 mm or 1 mm) at which a burning-time of 30 seconds is not exceeded and the sample does not drip when burning. This test is of particular interest in the field of electrical engineering or electronics, since components in electronic products may assume such high temperatures in the event of a fault or in the event of overload that parts in the immediate vicinity may ignite. In the glow-wire test such a thermal stress is simulated.

In a special form of the glow-wire test, the glow-wire ignition test according to IEC 60695-1-13, the focus of attention is the ignition behaviour of the test specimen. In this test the sample must not ignite during the testing process, in which connection ignition is defined as the appearance of flame for longer than 5 seconds. A burning dripping of the sample is not permitted.

Mechanical Properties:

Investigations relating to mechanical properties of the compositions may be carried out in accordance with the following standards:

The impact strength can be determined in accordance with DIN EN ISO 180, EN ISO 20180, ASTM D256, DIN EN ISO 179, DIN EN 20179, DIN 53453 or corresponding standards.

Determination of the Izod notched impact strength may be effected here, for example, in accordance with ISO 180/1A, ISO 180/1AR or in accordance with ISO 180/1B in respect of test samples with geometry 80*10*4 mm³ or in accordance with ISO 180/4A in respect of test samples with geometry 63.5*12.7*3.2 mm³.

The measurement of the notched impact strength according to Charpy is carried out, for example, in accordance with ISO 179/1eA, ISO 179/1eB or ISO 179/eC or alternatively ISO 179/1fA, ISO 179/1fB or IS0179/1fC in respect of test samples with geometry 80*10*4 mm³ or 63.5*12.7*3.2 mm³.

The tensile impact strength of notched and un-notched test specimens can be ascertained in accordance with DIN EN ISO 8256, DIN EN 28256, DIN 53448 or corresponding standards.

Further mechanical parameters—such as tensile modulus, yield stress, stretch elongation, breaking stress, breaking elongation or nominal breaking elongation—can be obtained from a tensile test according to DIN EN ISO 527, DIN EN 20527, DIN 53455/53457, DIN EN 61, ASTM D638 or corresponding standards.

Stress parameters and elongation parameters—such as, for example, flexural modulus of elasticity, bending stress in the case of conventional flexure (3.5% bending stress), bending strength, bending elongation at bending strength, bending stress in the event of fracture or bending elongation in the event of fracture—are provided by a bending test according to DIN EN ISO 178, DIN EN ISO 20178, DIN 53452/53457, DIN EN 63, ASTM D790 or corresponding standards.

The Vicat softening temperature (VST) can be established in accordance with DIN ISO 306, ASTM D1525 or corresponding standards.

Force parameters and flexure parameters are obtained from a penetration test according to DIN EN ISO 6603-2 or corresponding standards.

Weathering:

The weathering of samples can be implemented by various methods. These include, inter alia, the Xenon-WOM process according to ASTM G6, ASTM G151, ASM G155, DIN EN ISO 4892-2, SAE J 1885 or VDA 75202, the LSL-WOM process according to DIN EN ISO 4892-3, the Xenotest® High Energy according to DIN EN ISO 4892-2 or DIN EN 50014, the spray-mist test according to ASTM B117, DIN 50021, DIN EN ISO 7253, DIN EN 9227 or ISO 11503 and also the QUV test according to ISO 4892-3 or ASTM G154 and ASTM G53.

Rheological Properties:

Determination of the melt index (MFR, MVR) is effected in accordance with ISO 1133 or in accordance with ASTM D1238 MVR.

The melt viscosity is measured in accordance with ISO 11443 or DIN 54811.

Solution viscosities can be ascertained, for example, in accordance with standards ISO 1628-1/-4 or DIN 51562-3.

Optical Measurements:

Determination of the degree of gloss can be effected with a reflectometer in respect of sheets with geometry 60*40*2 mm³, whereby in addition to thicknesses of 2 mm those of 3 mm, 3.2 mm and 4 mm also enter into consideration. DIN 67530, ISO 2813, ASTM D523 or corresponding standards find application for this measurement.

Determinations of haze and transmission are effected in accordance with DIN 5306, ASTM D1003, ASTM E179 or ISO 13468.

The yellowness index YI is calculated in accordance with ASTM E313.

Reflection measurements may be carried out in accordance with DIN 5036 or ASTM E179.

For the purpose of determining the grey scale, ISO 105-A02 may be drawn upon.

### EXAMPLES

### PRODUCTION OF EXAMPLES

The device for compounding consists of
Metering device for the components
A co-rotating twin-shaft kneader (ZSK 53 produced by Werner & Pfleiderer) with a screw diameter of 53 mm
An orifice nozzle for the shaping of melt strands
A water bath for cooling and consolidating the strands
A granulator.

With the aid of the compounding device described above, the following compositions of Examples 1 to 14 are produced.

Makrolon® 2808 550115 is commercially available from Bayer MaterialScience AG.

Makrolon® 2808 550115 has EU/FDA quality and contains no UV absorber. The melt volume rate of flow (MVR) according to ISO 1133 amounts to 9.5 cm³/(10 min) at 300° C. and with 1.2 kg loading.

Makrolon® 3108 550115 is commercially available from Bayer MaterialScience AG.

Makrolon® 3108 550115 has EU/FDA quality and contains no UV absorber. The melt volume rate of flow (MVR) according to ISO 1133 amounts to 6.0 cm³/(10 min) at 300° C. and with 1.2 kg loading.

In the course of production of the compounds in Examples 1-9 the procedure is such that to 95 wt. % Makrolon® 2808 550115 granulate 5 wt. % of a powder mixture consisting of Makrolon® 3108 550115 powder, which contains the substances named in the Examples, is added in metered amounts, so that the mixtures (compounds) named in the Examples result.

In the course of production of the compound in Example 10 the procedure is such that to 75 wt. % Makrolon® 2808 550115 granulate 20 wt. % Makrolon® 3108 550115 granulate and 5 wt. % of a powder mixture consisting of Makrolon® 3108 550115 powder, which contains the UV-absorber named in the Example, is added in metered amounts, so that the mixture (compound) named in the Example results.

In the course of production of the compounds in Examples 11-14 the procedure is such that to 75 wt. % Makrolon® 2808 550115 granulate 5 wt. % of a powder mixture consisting of Makrolon® 3108 550115 powder, which contains the substances named in the Examples, is added in metered amounts, the bisphenol A diphosphate is added in metered amounts by addition of 20 wt. % of a previously produced master batch consisting of 85 wt. % Makrolon® 3108 550115 and 15 wt. % bisphenol A diphosphate (NcendX® P-30 produced by Albemarle).

Overall, the mixtures (compounds) named in the Examples result.

The device for compounding the master batch of bisphenol A diphosphate consists of:
Metering device for the components
A co-rotating twin-shaft kneader (Evolum 32 High Torque produced by Clextral) with a screw diameter of 32 mm
The bisphenol A disphosphate was injected into the extruder at 75-80° C. via a LEWA pump at 20 bar
An orifice nozzle for the shaping of melt strands
A water bath for cooling and consolidating the strands
A granulator.

### EXAMPLES

### Example 1

95.00 wt. % Makrolon® 2808 550115
4.90 wt. % Makrolon® 3108 550115
0.10 wt. % 2-[2-hydroxy-4-(2-ethylhexyl)oxy]phenyl-4,6-di(4-phenyl)phenyl-1,3,5-triazine

### Example 2

95.00 wt. % Makrolon® 2808 550115
4.85 wt. % Makrolon® 3108 550115
0.10 wt. % 2-[2-hydroxy-4-(2-ethylhexyl)oxy]phenyl-4,6-di(4-phenyl)phenyl-1,3,5-triazine
0.05 wt. % potassium nona-fluoro-1-butanesulfonate (Bayowet® C4 produced by Lanxess)

### Example 3

95.00 wt. % Makrolon® 2808 550115
4.95 wt. % Makrolon® 3108 550115
0.05 wt. % potassium nona-fluoro-1-butanesulfonate (Bayowet® C4 produced by Lanxess)

### Example 4

95.00 wt. % Makrolon® 2808 550115
4.30 wt. % Makrolon® 3108 550115
0.10 wt. % 2-[2-hydroxy-4-(2-ethylhexyl)oxy]phenyl-4,6-di(4-phenyl)phenyl-1,3,5-triazine
0.60 wt. % potassium diphenylsulfonic acid sulfonate

### Example 5

95.00 wt. % Makrolon® 2808 550115
4.40 wt. % Makrolon® 3108 550115
0.60 wt. % potassium diphenylsulfonic acid sulfonate

### Example 6

95.00 wt. % Makrolon® 2808 550115
3.90 wt. % Makrolon® 3108 550115
0.10 wt. % 2-[2-hydroxy-4-(2-ethylhexyl)oxy]phenyl-4,6-di(4-phenyl)phenyl-1,3,5-triazine
1.00 wt. % tetrabromobisphenol A oligocarbonate BC-52 HP produced by Chemtura

### Example 7

95.00 wt. % Makrolon® 2808 550115
4.00 wt. % Makrolon® 3108 550115
1.00 wt. % tetrabromobisphenol A oligocarbonate BC-52 HP produced by Chemtura

### Example 8

95.00 wt. % Makrolon® 2808 550115
4.30 wt. % Makrolon® 3108 550115
0.10 wt. % 2-[2-hydroxy-4-(2-ethylhexyl)oxy]phenyl-4,6-di(4-phenyephenyl-1,3,5-triazine
0.10 wt. % PD5 (Phenyltris(trimethylsiloxy)silane) produced by Momentive Performance Materials
0.50 wt. % potassium diphenylsulfonic acid sulfonate

### Example 9

95.00 wt. % Makrolon® 2808 550115
4.40 wt. % Makrolon® 3108 550115
0.10 wt. % PD5 (Phenyltris(trimethylsiloxy)silane) produced by Momentive Performance Materials
0.50 wt. % potassium diphenylsulfonic acid sulfonate

### Example 10

75.00 wt. % Makrolon® 2808 550115
24.90 wt. % Makrolon® 3108 550115
0.10 wt. % 2-[2-hydroxy-4-(2-ethylhexyl)oxy]phenyl-4,6-di(4-phenyl)phenyl-1,3,5-triazine

### Example 11

75.00 wt. % Makrolon® 2808 550115
4.90 wt. % Makrolon° 3108 550115
0.10 wt. % 2-[2-hydroxy-4-(2-ethylhexyl)oxy]phenyl-4,6-di(4-phenyl)phenyl-1,3,5-triazine
20.00 wt. % master batch of bisphenol A diphosphate (corresponds to 3.00 wt. % bisphenol A diphosphate)

### Example 12

75.00 wt. % Makrolon® 2808 550115
5.00 wt. % Makrolon® 3108 550115
20.00 wt. % master batch of bisphenol A diphosphate (corresponds to 3.00 wt. % bisphenol A diphosphate)

### Example 13

75.00 wt. % Makrolon® 2808 550115
4.40 wt. % Makrolon® 3108 550115
0.10 wt. % 242-hydroxy-4-(2-ethylhexyl)oxy]phenyl-4,6-di(4-phenyl)phenyl-1,3,5-triazine
0.50 wt. % Blendex® B449 produced by Chemtura (a PTFE/SAN Blend, weight ratio 50/50)
20.00 wt. % master batch of bisphenol A diphosphate (corresponds to 3.00 wt. % bisphenol A diphosphate)

### Example 14

75.00 wt. % Makrolon® 2808 550115
4.50 wt. % Makrolon® 3108 550115
0.50 wt. % Blendex® B449 produced by Chemtura
20.00 wt. % master batch of bisphenol A diphosphate (corresponds to 3.00 wt. % bisphenol A diphosphate)

The compounds of Examples 1 to 12 are subsequently processed into test specimens with geometry 63.5*12.7*3.2 mm³. This is done with an Arburg Allrounder 270S-500-60 having a screw diameter of 18 mm.

The compounds of Examples 10, 13 and 14 are subsequently processed into test specimens with geometry 63.5*12.7*1.0 mm³. This is done with an Arburg Allrounder 270S-500-60 having a screw diameter of 18 mm.

| | Compounds from |
|---|---|
| Process parameter | Examples 1 to 14 |
| Extruder heating zones | |
| Extruder Z1 | 290° C. |
| Extruder Z2 | 295° C. |
| Extruder Z3 | 300° C. |
| Extruder Z4 | 300° C. |
| Tool temperature | 95° C. |
| Injection pressure (max.) | 1600 bar |
| Holding pressure (supporting point 1) | 1200 bar |
| Holding pressure (supporting point 2) | 1000 bar |
| Holding pressure (supporting point 3) | 800 bar |
| Back pressure | 100 bar |

Subsequently 4 sets, each of 5 UL test specimens (in total, 20 UL test specimens were tested), were gauged in accordance with UL94V. Two sets were measured after storage for 48 h at 50% rel. air humidity and at 23° C. Two sets were measured after storage for 7 d at 70° C. in a hot-air furnace.

The test results are shown in table 1.

TABLE 1

| | Number V0 | Number V1 | Number V2 | Number Vn.p |
|---|---|---|---|---|
| Example 1* | | | 1 × V2 | 3 × Vn.p |
| Example 2 | 4 × V0 | | | |
| Example 3* | 3 × V0 | 1 × V1 | | |
| Example 4 | 4 × V0 | | | |
| Example 5* | 3 × V0 | 1 × V1 | | |
| Example 6 | 1 × V0 | | 3 × V2 | |
| Example 7* | | | 3 × V2 | 1 × Vn.p |
| Example 8 | 3 × V0 | | 1 × V2 | |
| Example 9* | 2 × V0 | 2 × V1 | | |
| Example 10* | | | 1 × V2 | 3 × Vn.p |
| Example 11 | | | 3 × V2 | 1 × Vn.p |
| Example 12* | | | 4 × V2 | |
| Example 13 | 4 × V0 | | | |
| Example 14* | 3 × V0 | 1 × V1 | | |

*comparison
n.p. = not passed

Table 1 shows that the addition of the UV-stabilizer improves the flame retardant property of the composition.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Composition containing polycarbonate and 0.0001 wt. % to 0.5 wt. % 2-[2-hydroxy-4-(2-ethylhexyl)oxy]phenyl-4,6-di(4-phenyl)phenyl-1,3,5-triazine and 0.01 wt. % to 30.00 wt. % of a flameproofing additive.

2. Composition according to claim 1, wherein the flameproofing additive is an organic flameproofing salt.

3. Composition according to claim 2, wherein the flameproofing additive is an alkali or alkaline-earth salt of an aliphatic or aromatic derivative of sulfonic acid, sulfonamide or sulfonimide.

4. Composition according to claim 3, wherein the organic flameproofing salt is sodium or potassium nona-fluoro-1-butanesulfonate.

5. Composition according to claim 3, wherein the organic flameproofing salt is sodium or potassium diphenylsulfonic acid sulfonate.

6. Composition according to claim 3, wherein a flameproofing additive mixture is employed consisting of sodium or potassium nona-fluoro-1-butanesulfonate and sodium or potassium diphenylsulfonic acid sulfonate.

7. Composition according to claim 1, wherein the flameproofing additive is a halogen-containing flameproofing additive.

8. Composition according to claim 7, wherein the halogen-containing flameproofing additive is tetrabromobisphenol A oligocarbonate (TBBOC).

9. Composition according to claim 1, wherein the flameproofing additive is a siloxane.

10. Composition according to claim 1, wherein the flameproofing additive is a phosphorus-containing flameproofing additive.

11. Composition according to claim 10, wherein the phosphorus-containing flameproofing additive is triphenyl phosphate (TPP) or bisphenol A diphosphate (DBP) or resorcinol diphosphate (RDP).

12. Composition according to claim 11, wherein mixtures of the phosphorus-containing flameproofing additives are included.

13. Composition according to claim 3, wherein mixtures of the flameproofing additives are included.

14. Composition according to claim 1, wherein polytetrafluoroethylene or a polytetrafluoroethylene blend is included in addition.

15. Composition according to claim 1, wherein the composition additionally contains 10 ppm to 3000 ppm thermo stabilisers, relative to the total mass of the composition.

16. Composition according to claim 15, wherein the thermo stabiliser is selected from the group consisting of tris-(2,4-di-tert.-butylphenyl)phosphate and triphenyl phosphine.

17. Product containing a composition according to claim 1.

18. Product according to claim 17, wherein the product constitutes a single-layer or multi-layer solid, multi-wall or corrugated sheet, with one or more of the layers of the sheet containing a composition according to one of claims 1 to 7.

19. Product according to claim 17, wherein the product is produced in an injection-moulding process.
